(19) United States
(12) Patent Application Publication
(10) Pub. No.: US 2007/0032910 A1
(43) Pub. Date: Feb. 8, 2007

(54) Apparatus for dispensing precise volumes of fluid

(75) Inventor: James P. Garcia, Santa Clara, CA (US)

Correspondence Address: BRINKS HOFER GILSON & LIONE, P.O. BOX 10395, CHICAGO, IL, 60610, US

(73) Assignee: Lam Research Corporation

(21) Appl. No.: 11/580,326

(22) Filed: Oct. 13, 2006

Related U.S. Application Data
(62) Division of application No. 10/954,707, filed on Sep. 30, 2004.

(51) Int. Cl. G05D 11/00

(52) U.S. Cl. 700/283

(57) ABSTRACT

A dispensing measuring system for dispensing a measure of fluid for use with a system to treat semiconductor workpieces is disclosed. The dispensing measuring system includes at least one feedline having a receiving tank having a volumetric capacity for receiving a measure of fluid. A sensor senses when the receiving tank has received the measure of fluid. A mix tank is attached to the at least one feedline for receiving the measure of fluid from the receiving tank to create a batch of fluid. A controller is electrically connected to the at least one feedline to control the flow of fluid through the at least one feedline. The controller is electrically connected to the mix tank. A connecting line is attached to the mix tank.

### RELATED APPLICATIONS

This application is a divisional application of U.S. application Ser. No. 10/954,707, filed on Sep. 30, 2004, entitled “AN APPARATUS FOR DISPENSING PRECISE VOLUMES OF FLUID.”

### FIELD OF INVENTION

The present invention relates generally to equipment for processing semiconductor workpieces. More particularly, the present invention relates to dispensing fluid for use in connection with a system to treat semiconductor workpieces.

### BACKGROUND

In the semiconductor chip fabrication process, it is well-known that there is a need to process a wafer using operations such as etching, cleaning, drying, and plating. In each of these types of operations, liquids are typically either applied and or removed fluids for the etching, cleaning, drying, and plating processes.

For example, wafer cleaning may have to be conducted where a fabrication operation has been performed that leaves unwanted residues on the surfaces of wafers. Examples of such a fabrication operation include plasma etching (e.g., tungsten etch back (WEB)) and chemical mechanical polishing (CMP). In CMP, a wafer is placed in a holder which pushes a wafer surface against a moving pad. This moving pad uses a slurry which consists of chemicals and abrasive materials to cause the polishing. Unfortunately, this process tends to leave an accumulation of slurry particles and residues at the wafer surface. If left on the wafer, the unwanted residual material and particles may cause, among other things, defects such as scratches on the wafer surface and inappropriate interactions between metallization features. In some cases, such defects may cause devices on the wafer to become inoperable. In order to avoid the undue costs of discarding wafers having inoperable devices, it is therefore necessary to clean the wafer adequately yet efficiently after fabrication operations that leave unwanted residues.

After a wafer has been wet cleaned, the wafer must be dried effectively to prevent water or cleaning fluid remnants from leaving residues on the wafer. If the cleaning fluid on the wafer surface is allowed to evaporate, as usually happens when droplets form, residues or contaminants previously dissolved in the cleaning fluid will remain on the wafer surface after evaporation (e.g., and form spots). To prevent evaporation from taking place, the cleaning fluid must be removed as quickly as possible without the formation of droplets on the wafer surface. In an attempt to accomplish this, one of several different drying techniques are employed such as spin drying, IPA, or Marangoni drying. All of these drying techniques utilize some form of a moving liquid/gas interface on a wafer surface which, if properly maintained, results in drying of a wafer surface without the formation of droplets. Unfortunately, if the moving liquid/gas interface breaks down, as often happens with all of the aforementioned drying methods, droplets form and evaporation occurs resulting in contaminants being left on the wafer surface. The most prevalent drying technique used today is spin rinse drying (SRD).

In a SRD drying process this drying process, a wet wafer is rotated at a high rate by rotation. In SRD, by use of centrifugal force, the water or cleaning fluid used to clean the wafer is pulled from the center of the wafer to the outside of the wafer and finally off of the wafer. As the cleaning fluid is being pulled off of the wafer, a moving liquid/gas interface is created at the center of the wafer and moves to the outside of the wafer (i.e., the circle produced by the moving liquid/gas interface gets larger) as the drying process progresses. Therefore, as the drying process continues, the section inside (the dry area) of the moving liquid/gas interface increases while the area (the wet area) outside of the moving liquid/gas interface decreases. As stated previously, if the moving liquid/gas interface breaks down, droplets of the cleaning fluid form on the wafer and contamination may occur due to evaporation of the droplets. As such, it is imperative that droplet formation and the subsequent evaporation be limited to keep contaminants off of the wafer surface. Unfortunately, the present drying methods are only partially successful at the prevention of moving liquid interface breakdown.

In addition, the SRD process has difficulties with drying wafer surfaces that are hydrophobic. Hydrophobic wafer surfaces can be difficult to dry because such surfaces repel water and water based (aqueous) cleaning solutions. Therefore, as the drying process continues and the cleaning fluid is pulled away from the wafer surface, the remaining cleaning fluid (if aqueous based) will be repelled by the wafer surface. As a result, the aqueous cleaning fluid will want the least amount of area to be in contact with the hydrophobic wafer surface. Additionally, the aqueous cleaning solution tends cling to itself as a result of surface tension (i.e., as a result of molecular hydrogen bonding). Therefore, because of the hydrophobic interactions and the surface tension, balls (or droplets) of aqueous cleaning fluid form in an uncontrolled manner on the hydrophobic wafer surface. This formation of droplets results in the harmful evaporation and the contamination discussed previously. The limitations of the SRD are particularly severe at the center of the wafer, where centrifugal force acting on the droplets is the smallest. Consequently, although the SRD process is presently the most common way of wafer drying, this method can have difficulties reducing formation of cleaning fluid droplets on the wafer surface especially when used on hydrophobic wafer surfaces.

Additionally, in other wafer processing operations such as cleaning, etching, and plating, there are also problems with applying the fluids to the wafer and removing fluids from the wafer in an efficient manner that decreases contamination and increases wafer yield. Therefore, there is a need for a method and an apparatus that enables optimized fluid management and application to a wafer via an improved chemical dispensing measurement system.

### BRIEF SUMMARY

In order to address the need for improved chemical dispensing measuring systems, a dispensing measuring system for dispensing a measure of fluid for use with a process associated with a wafer processing system is provided that includes at least one feedline having a receiving tank. The receiving tank has a volumetric capacity for receiving a measure of fluid and a sensor for sensing when the receiving tank has received the measure of fluid. A mix tank is attached to the at least one feedline for receiving the measure of fluid from the receiving tank to create a batch of fluid. A controller is electrically connected to the at least one feedline to control the flow of fluid through the at least one feedline. The controller is electrically connected to the mix tank. A connecting line is attached to the mix tank.

Another aspect of the dispensing measuring system includes two feedlines, with each feedline having a receiving tank having a volumetric capacity for receiving a measure of fluid. The measure of fluid of the receiving tanks are different from each other, and a sensor associated with each receiving tank senses when the receiving tank has received the measure of fluid. A mix tank is attached to the feedlines for receiving the measure of fluid from the receiving tanks to create a batch of fluid. A controller is electrically connected to the feedlines to control the flow of fluid through the feedlines and is electrically connected to the mix tank. A connecting line is attached to the mix tank.

A method for dispensing fluid through a fluid dispensing measuring system is also included herein. The fluid dispensing measuring system includes having at least a first receiving tank having a volumetric capacity for receiving a first measure of fluid, a first sensor for sensing the first measure of fluid within the first receiving tank, a mix tank connected with the first receiving tank, a mix sensor for sensing a batch of fluid, and a source of fluid. The method includes: a) providing the first measure of fluid from the source to the first receiving tank; b) sensing with the first sensor when the first measure of fluid has been received by the first receiving tank; and c) transferring the first measure of fluid from the first receiving tank to the mix tank.

Another aspect of the method includes: a) providing a first measure of fluid from a source of fluid to a first receiving tank; b) sensing with a sensor when the first measure of fluid has been received by the first receiving tank; and c) pumping less than the first measure of fluid from the first receiving tank to a mix tank with a micro dispenser.

A computer readable medium being program code recorded thereon for calculating volumes to dispense fluid to a fluid dispensing measuring system for creating a chemical batch of fluid for use with any wafer processing system is also included. The chemical batch of fluid has a chemical batch volume. The chemical batch includes at least a first chemical and deionized water. The chemical dispensing measuring system includes a first and a second receiving tank receiving a first measure and a second measure of fluid, respectively. The program code includes instructions for calculating a fluid volume for the first chemical. A count factor for the first chemical is calculated by dividing the fluid volume of the first chemical by the total measure of fluid of the first and the second receiving tanks. The count factor includes a whole number portion and a decimal portion. A number of double shots of the first chemical to be dispensed by the fluid dispensing measuring system is determined. The number of double-shots is equal to the whole number portion of the count factor. A micro dispenser volume to be pumped using a micro dispenser is also determined.

### BRIEF DESCRIPTION OF THE DRAWINGS

FIG. 1 is a view of a first embodiment of a chemical dispensing measuring system;

FIG. 2 is a view of a second embodiment of a chemical dispensing measuring system;

FIG. 3 is a view of a third embodiment of a chemical dispensing measuring system;

FIG. 4 is a diagram of an algorithm for dispensing fluids to a mix tank;

FIG. 5 shows a process of dispensing a double shot of fluid;

FIG. 6 shows a process of dispensing fluid from a micro dispenser;

FIG. 7 shows a process of dispensing a single shot of fluid from a first receiving tank and fluid from a micro dispenser; and

FIG. 8 shows a process of dispensing a single shot of fluid from a second receiving tank and fluid from a micro dispenser.

### DETAILED DESCRIPTION OF THE DRAWINGS AND THE PRESENTLY PREFERRED EMBODIMENTS

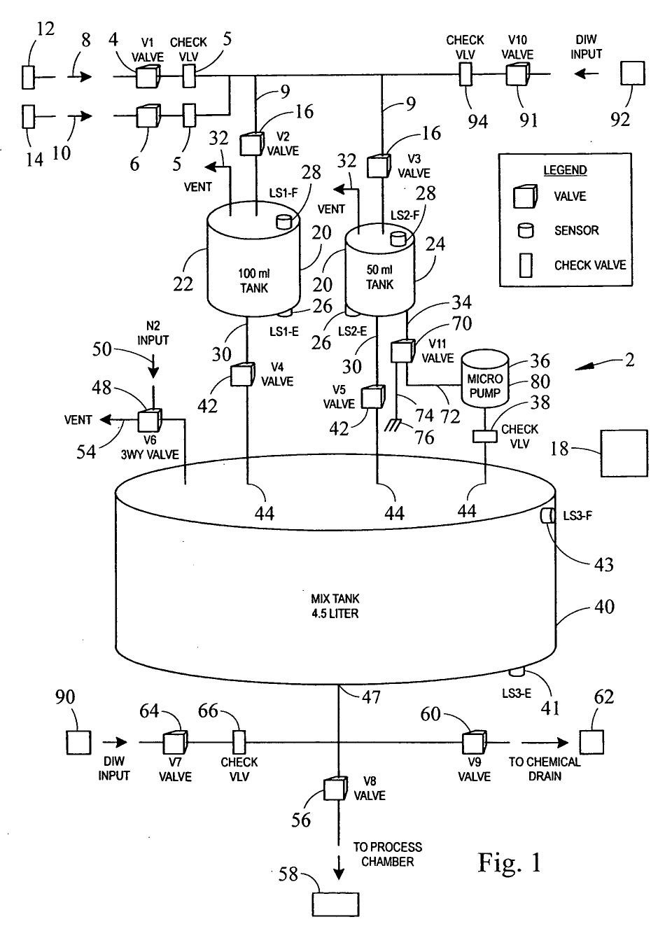

Referring now to the drawings, FIG. 1 is a perspective view of a fluid dispensing measuring system 2. The dispensing measuring system 2 typically is for use with a wafer processing system (not shown) for cleaning or drying a workpiece. However, the operative principles embodied in the dispensing measuring system 2 may be applied to other wafer processing techniques such as chemical mechanical polishing of other workpieces as well.

The dispensing measuring system may be employed in a wafer cleaning system held in close proximity to the wafer surface such that a meniscus is formed between the cleaning device and the wafer surface. The surface tension gradient of the fluid is maintained between the surfaces and controlled by the dispensing measurement system so that the cleaning device, otherwise known as a proximity head, may be moved relative to the wafer surface in any number of ways such as scanning linearly or sweeping, or scanning from center to edge while a wafer is rotated. Various proximity heads and methods of using the proximity heads are described in co-owned U.S. patent application Ser. No. 10/330,843 filed on Dec. 24, 2002 and entitled “Meniscus, Vacuum, IPA Vapor, Drying Manifold,” which is a continuation-in-part of U.S. patent application Ser. No. 10/261,839 filed on Sep. 30, 2002 and entitled “Method and Apparatus for Drying Semiconductor Wafer Surfaces Using a Plurality of Inlets and Outlets Held in Close Proximity to the Wafer Surfaces,” both of which are incorporated herein by reference in its entirety. Additional embodiments and uses of the proximity head are also disclosed in U.S. patent application Ser. No. 10/330,897, filed on Dec. 24, 2002, entitled “System for Substrate Processing with Meniscus, Vacuum, IPA vapor, Drying Manifold”; and, U.S. patent application Ser. No. 10/404,692, filed on Mar. 31, 2003, entitled “Methods and Systems for Processing a Substrate Using a Dynamic Liquid Meniscus”. Still additional embodiments of the proximity head are described in U.S. patent application Ser. No. 10/404,270, filed on Mar. 31, 2003, entitled “Vertical Proximity Processor”; U.S. patent application Ser. No. 10/603,427, filed on Jun. 24, 2003, entitled “Methods and Systems for Processing a Bevel Edge of a Substrate Using a Dynamic Liquid Meniscus”; U.S. patent application Ser. No. 10/606,022, filed on Jun. 24, 2003, and entitled “System and Method for Integrating In-Situ Metrology within a Wafer Process”; U.S. patent application Ser. No. 10/607,611, filed on Jun. 27, 2003, entitled “Apparatus and Method for Depositing and Planarizing Thin Films of Semiconductor Wafers”; U.S. patent application Ser. No. 10/611,140, filed on Jun. 30, 2003, entitled “Method and Apparatus for Cleaning a Substrate Using Megasonic Power”; U.S. patent application Ser. No. 10/742,303, filed on Dec. 18, 2003, entitled “Proximity Brush Unit Apparatus and Method”; U.S. patent application Ser. No. 10/816,432, filed Mar. 31, 2004, entitled “Substrate Brush Scrubbing and Proximity Cleaning-Drying Sequence Using Compatible Chemistries, and Method, Apparatus, and System for Implementing the Same”; U.S. patent application Ser. No. 10/817,133, filed on Apr. 1, 2004, entitled “Proximity Meniscus Manifold ”; U.S. patent application Ser. No. 10/883,301, filed on Jun. 30, 2004, entitled “Concentric Proximity Processing Head”; U.S. patent application Ser. No. 10/882,716, filed on Jun. 30, 2004, entitled “Proximity Substrate Preparation Sequence and Method, Apparatus, and System for Implementing the Same”; and, U.S. patent application Ser. No. 10/882,835, filed Jun. 30, 2004, entitled “Method and Apparatus for Processing Wafer Surfaces Using Thin, High Velocity Fluid Layer.” The aforementioned patent applications are hereby incorporated by reference in their entirety.

The dispensing measuring system includes a pair of valves 4, 6, that, when open, each allows the passage of a fluid in the direction of arrows 8, 10, respectively to a line feed 9. A check valve 5 is associated with each valve 4, 6, to prevent the backflow of fluid. Note that although there may be numerous line feeds, a preferred embodiment will include two line feeds. The fluid that passes through each valve originates from a source, 12, 14. As will be described further below, a preferred embodiment contemplates the passage of fluid from only one source at a time, although those skilled in the art will see how the system may be modified to allow the passage of two sources of fluid concurrently.

The fluids may be different from each other or may be of the same composition. The fluid may be of any type that is suitable for use with processes involving semiconductor wafers. Suitable examples include, but are not limited to, hydrofluoric acid, hydrogen-peroxide, deionized water, ammonium-hydroxide, and sulfuric acid.

The system 2 also includes a normally-closed inlet valve 16 associated with each line feed 9. Preferably, the inlet valve is a standard, chemical-resistant two-way valve, such as that available through Entegris, Inc. of Chaska, Minn. The inlet valve may be pneumatic, electromechanical, or of any type suitable for controlling the passing of fluid.

The system is controlled by a controller 18 electrically connected with the system 2. The controller 18 communicates electrical signals to and from the system 2. When a fluid passes through the system 2, the controller 18 provides electrical signals to open/close the various components associated with the feedlines 9 that are discussed below.

Upon passing through the valves, the fluid will pass through an inlet 19 into a receiving tank 20, with one receiving tank being associated with each line feed. Preferably, the receiving tanks are of different sizes, and more preferably a first receiving tank 22 has a volume of approximately 100 milliliters (ml) and a second receiving tank 24 has a volume of approximately 50 ml. However, the receiving tanks may be otherwise sized and may in fact be the same size. The receiving tanks, as well as the feedlines 9 and associated components, are preferably made of materials that will not corrode and is inert when exposed to chemicals of the type listed above. Suitable examples include but are not limited to polytetrafluoroethylene, steel, polyvinylidene fluoride or chemical-resistant plastics.

First and second sensors 26, 28 are associated with each receiving tank 20. The first sensor 26 senses when the receiving tank does not contain fluid. The second sensor 28 senses when the receiving tank contains a measure of fluid. The sensors are of a non-invasive type that do not contact the fluid but instead may sense the fluid from the exterior of the tank. Preferably, the sensors are capacitive sensors and are adjustable. Normally, the sensors 26, 28 will be adjusted so that they sense when the receiving tank is empty of fluid and contains fluid at fill capacity, respectively. However, depending on the amount of fluid that is desired for the receiving tank to contain, the first and/or second sensors may be otherwise adjusted. For example, the sensor 28 may be adjusted to sense a measure of fluid that is less than the full capacity of the receiving tank 20.

The receiving tank 20 also includes an outlet 30 and a vent 32. The outlet 30 allows fluid in the tank to pass from the tank. The vent 30 associated with each receiving tank 20 allows for the displacement of air from the receiving tank when the receiving tank is filling with fluid.

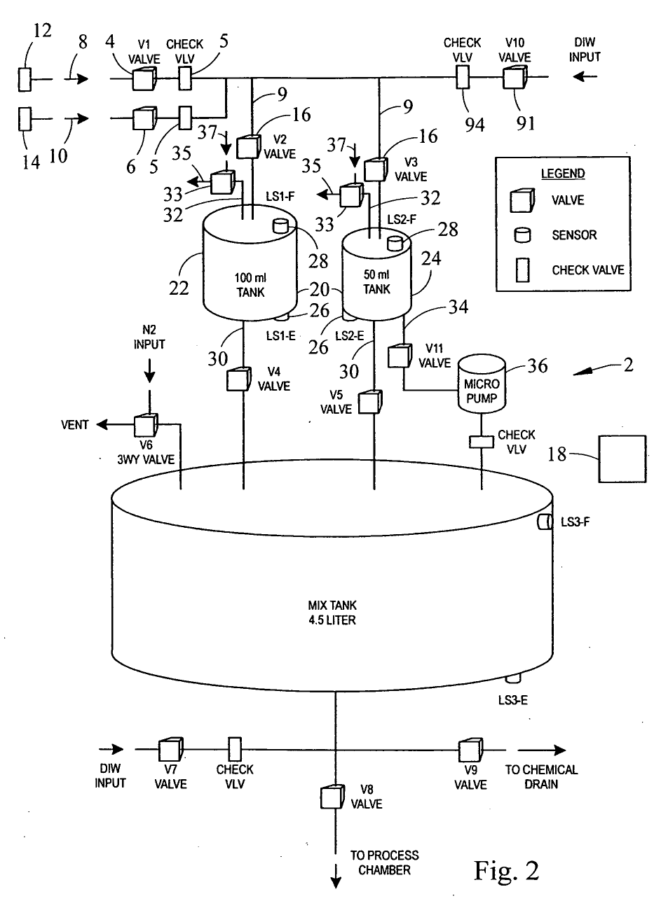

Note that the fluid passing through the feedline 9 may be either gravity-fed or pressurized in order to pass from each of the sources through feedlines 9. For gravity-fed embodiments, this means that the various components of the system 2 should be positioned so that fluid flows through the system 2 via gravity acting on the fluid, i.e., so fluid flows in a downwardly direction in accordance with a gravitational pull acting on the fluid. For embodiments using a pressurized fluid, the vent 32 may include a valve 33. FIG. 2 shows an embodiment of the system that includes valve 33, with common components being labeled the same. The valve 33 is a 3-way valve, with the arrow indicated by 35 showing the passage of air from the vent, and with the arrow indicated by 37 showing the passage of a pressurized gas such as nitrogen being introduced into the receiving tank in order to pressurize the fluid. If the fluid is pressurized, a desirable pressure often will be 6 pounds per square inch, although in other embodiments other pressure values may be used.

Preferably, at least one of the receiving tanks 20 includes a second outlet 34. The second outlet 34 allows fluid to pass from the receiving tank 20, through a dispenser valve 70 and then to a micro dispenser 36 that is connected with the receiving tank 20. The micro dispenser 36 will transfer a volume of fluid from the receiving tank 20 that is less than the measure of fluid associated with the receiving tank 20 with which the micro dispenser 36 is attached. Note that the measure of fluid may not only be based on the size of the receiving tank 20 but may also be based on the adjustment of the sensor 28 that senses when the receiving tank 20 contains fluid. For example, if the sensor 28 is adjusted to sense when fluid fills half of the receiving tank 20, the micro dispenser 36 will transfer a volume of fluid from the receiving tank 20 that is less than half the capacity of the receiving tank 20. The micro dispenser 36 may be associated with either receiving tank 22, 24. A check valve 38 is associated with the micro dispenser 36 to prevent the backflow of fluid after it passes from the micro dispenser 36.

In one embodiment, the micro dispenser 36 may be a micropump 80. The micropump 80 may be of any capacity, depending on system requirements, but typically will have a capacity of less than 50 ml (assuming that the micropump is attached to a receiving tank that receives a measure of fluid of 50 ml). Preferably the micropump is a self-priming, micro-dispensing, solenoid-actuated micropump, such as a pump available from Bio-Chem Valve Inc., Boonton, N.J., model nos. 090SP, 120SP or 150SP. Another example of a suitable pump is model no. Reglo Analog MS-2/6, a peristaltic pump available from Micropump, Inc. of Vancouver, Wash.

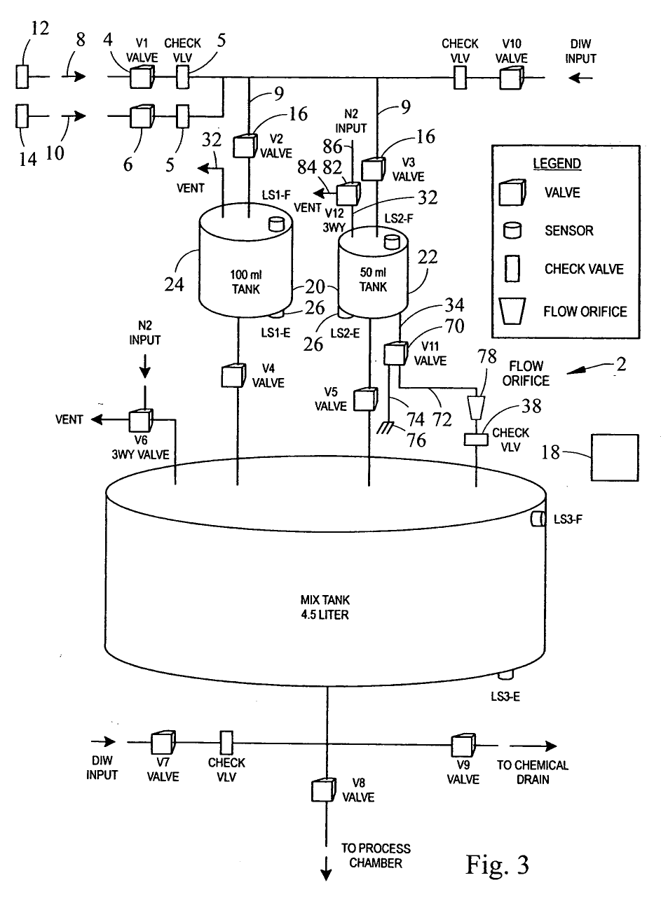

In another embodiment, the micro dispenser 36 may be a flow orifice dispenser 78. FIG. 3 shows an embodiment of a system 2 that includes a flow orifice dispenser 78, with common components being labeled the same. The flow orifice dispenser 78 passes fluid at a fixed flow rate. In order for the flow orifice dispenser 78 to operate efficiently, the inlet pressure of the fluid should be fixed. To fix the inlet pressure of fluid, a valve 82 may be attached at the vent 32 of the receiving tank 20. The valve 82 is a 3-way valve and may be the same type as the valve 33 described above. One “branch” of the valve 82, depicted as 84, allows for the displacement of air as described above. The other branch 86 allows the introduction of a pressurized gas such as nitrogen into the receiving tank 20 so that enters the flow orifice dispenser at a fixed inlet pressure.

The dispenser valve 70 is a 3-way valve. One branch of the dispenser valve 70, depicted as 72, isolates the micropump 36 from the receiving tank 22. Another branch of the valve, depicted as 74, acts as a purge leading to a drain 76 to empty the receiving tank 22 of any fluid not pumped out of the receiving tank 22 by the micropump 36 or otherwise dispensed.

A normally-closed outlet valve 42 is associated with each line feed 9. When opened, the outlet valve 42 allows fluid to exit from the receiving tank 20. The outlet valve 42 is of the same type as the inlet valve 16 described above. When the outlet valve 42 is opened, fluid from the receiving tank 20 passes into a mix tank 40.

The mix tank 40 receives fluids from the receiving tanks 20 via inlets 44, with there being a separate inlet 44 associated with each receiving tank 20 (and micro dispenser 36). The mix tank 40 provides a space for fluids from the various line feeds 9 to mix into a homogenous fluid. The mix tank 40 is of a construction similar to that of the receiving tank 20, i.e., of a material that will not corrode and is inert when exposed to chemicals such as those described above. The mix tank 40 should be of a total volumetric capacity that is at least equal to the total measure of fluid of the receiving tanks 20 and the volume of fluid that passes through the micro dispenser 36. Preferably, however, the mix tank will have a volumetric capacity of 4.5 liters. The mix tank also includes an outlet 47 that provides an egress for the mixed fluid.

The mix tank 40 also includes first and second mix sensors 41, 43. The first mix sensor 41 senses when no fluid remains in the mix tank. The second mix sensor 43 senses when a predetermined volume of a chemical batch is in the mix tank.

Preferably, the mix tank 40 includes a communication line 46 that has a mix valve 48 associated with it. The mix valve 48 is preferably a three-way valve that allows for a pressurized input, as shown by the arrow 50, in order to increase the flow rate of fluid that exits through the outlet 47 of the mix tank 40. The pressurized input may be a gas such as nitrogen. The mix valve 48 also allows air to pass from a vent, as depicted by the arrow 54, so that air may be displaced as fluid enters the mix tank 40.

Fluid is able to exit through the outlet 47 of the mix tank 40 when a normally-closed process valve 56 opens. The process valve 56 is similar to the inlet valve 16 described above. From there, fluid may flow to a process apparatus 58. The process valve is similar to the mix valve 48.

A water valve 64, also similar to the inlet valve 16, is included to allow a first source of deionized water 90 to flow to the mix tank 40 or the process apparatus 58. A check valve 66 prevents the “back-flow” of mixed fluid. Normally, after a required amount of chemicals have been dispensed to the mix tank 40, deionized water may be introduced to the mix tank until the mix tank sensor 43 senses fluid, thus making up a chemical batch.

Optionally, the dispensing measuring system 2 may include a drain valve 60, which is also similar to the inlet valve 16, to provide a drain, depicted by the arrow 62.

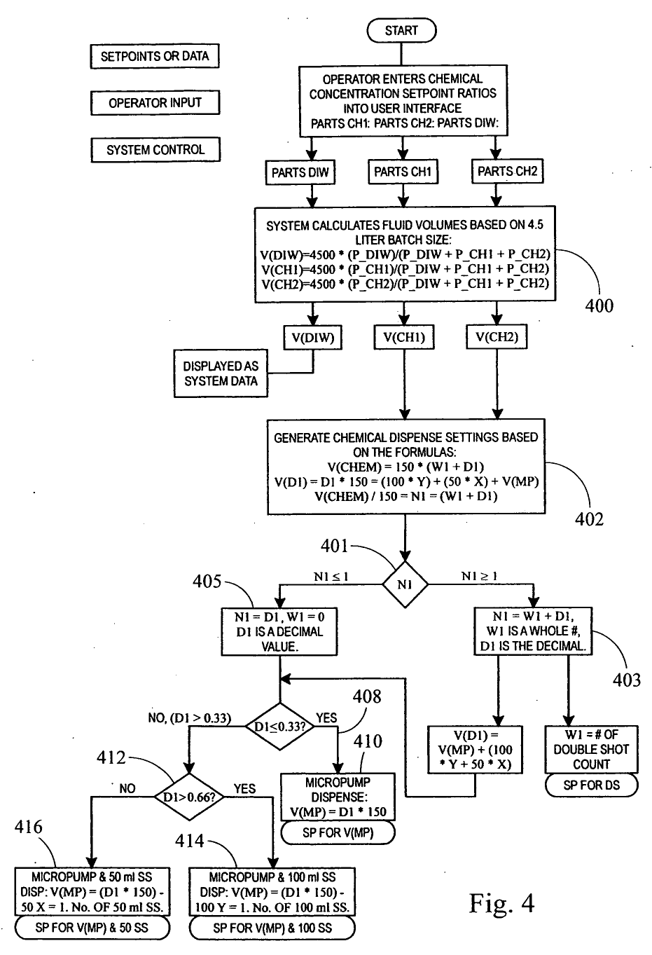

The process apparatus 58 is an apparatus that involves the processing of silicon wafer using techniques such as, for example, wafer cleaning, wafer etching, plating and lithography Referring to FIG. 4, the algorithms assume two mix tanks that receive measures of fluid equal to 100 ml and 50 ml, respectively, a desired chemical batch volume of 4500 ml and a chemical batch comprising Chemical 1, Chemical 2, and deionized water (Ch1, Ch2 and DIW, respectively). These algorithms will have been pre-programmed into a computer using program code of any suitable computer logic language. The required volumes V(Ch1), V(Ch2) and V(DIW) of Ch1, Ch2 and DIW are first calculated (at 400). The volumes are calculated by multiplying the chemical batch volume by the number of parts the chemical forms of the entire chemical batch volume divided by the total number of parts making up the entire chemical batch volume. Note that the “parts” making up the chemical batch will have been predetermined (e.g., a chemical batch made up of 3 parts Ch1, 1 part Ch2 and 15 parts DIW).

Once the required volume of each part of the chemical batch is determined, the chemical dispense settings are calculated (at 402). This requires determining: 1) the volume of each chemical to be dispensed using either the micro dispenser 36 and/or whether a single shot (SS) of chemical from either the 100 ml or 50 ml receiving tank (V(D1)) is to be dispensed; and 2) the number of times each chemical is to be dispensed using a double shot (DS) of both the 100 ml and 50 ml tanks (V(W1)). A “single shot” is when an amount of fluid from one of the receiving tanks, but not both, is dispensed. A “double shot” is when an amount of fluid is dispensed from both receiving tanks concurrently.

To calculate V(W1) and V(D1), a “count factor” N1 is first calculated. N1 is the equivalent of the total chemical volume (V(Ch1), V(Ch2) or V(DIW)) divided by the total measure of fluid of the receiving tanks (here 150 ml) (at 401). N1 is made up of a whole number portion (W1) and a decimal portion (D1). Following the logic diagram of FIG. 2, it is first determined whether N1 is greater than or equal to one. If N1 is greater than or equal to one, W1 is equal to the number of double-shot counts that make up the chemical batch (the number of times fluid is dispensed by both the 100 ml and 50 ml receiving tanks) (at 403). D1 is the number of micropump and/or single-shot dispense counts (the number of times fluid is dispensed from the micropump and/or one of the receiving tanks). Note that if D1 is equal to zero no fluid will be dispensed from the micropump and no single shots will be dispensed. Similarly, if W1 is equal to zero no double shots of fluid will be dispensed (at 405).

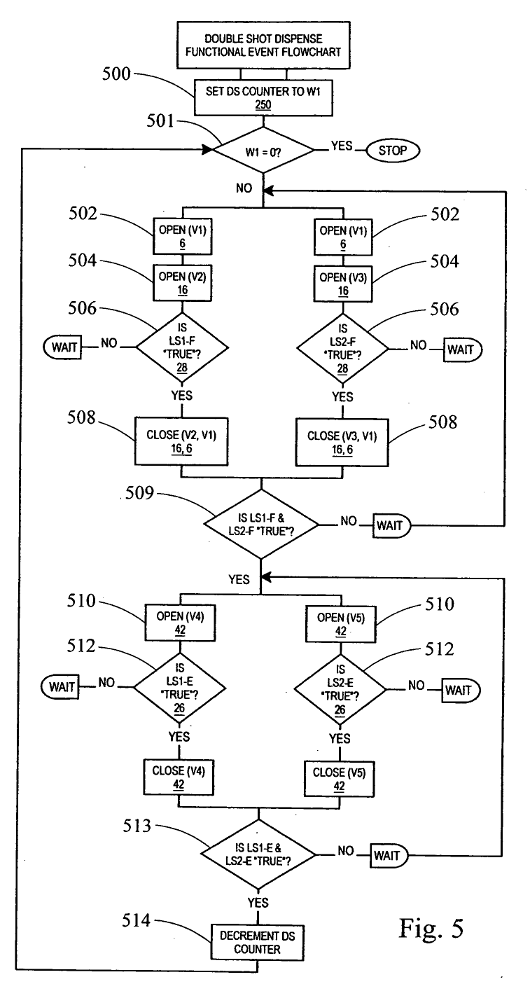

With respect to W1, FIG. 5 shows the process of concurrently dispensing fluid through both receiving tanks 22, 24 of the dispensing measuring system 2 described above, with the symbol references and component references used in FIG. 1 being referenced here. After determining that W1 is not equal to zero (at 501), fluid will pass through the valve 6 (or alternatively, valve 4, depending on the source of fluid being provided) and the inlet valves 16 associated with each feed line to pass to the receiving tanks 22, 24 (at 502, 504). Once the sensors 28 indicate that the receiving tanks contain a measure of fluid (at 506), the valves 6, 16 will close (at 508). Optionally, a “sanity check” may be provided to ensure that the sensors 28 indicate that the receiving tanks contain a measure of fluid (at 509). The outlet valves 42 associated with each feedline will then open (at 510). The outlet valves 2 will allow fluid to flow to the mix tank 40 and will remain open until the sensors 26 sense that fluid no longer remains in the receiving tanks 22, 24 (at 512). Optionally, a sanity check may be provided to ensure that the sensors sense that fluid no longer remains in the receiving tanks (at 513). A counter 250 is used to count the number of cycles for dispensing double-shots of fluid with the counter being initially set to W1 (at 500). The counter 550 is decreased each time a double shot of fluid is dispensed, with fluid ceasing to be dispensed once the counter is equal to zero (at 514). Note that in embodiments that include a flow orifice dispenser 78, the inlet fluid pressure will be fixed via the introduction of a pressurized gas through valve 82.

With respect to D1, if D1 is less than or equal to 0.33 (at 408), fluid will be dispensed from the micropump (with no single shots of fluid from a receiving tank being dispensed). The value of 0.33 is determined by dividing the smaller measure of fluid of the receiving tanks 22, 24 by the total measure of fluid of the receiving tanks combined. In this example this value is 50 divided by 150. Note that this value would change if the sensor 28 was adjusted to sense a measure of fluid within the receiving tank 24 at a value less than the total volumetric capacity (50 ml) of the receiving tank 24. The volume of fluid dispensed from the micro dispenser V(MD) is calculated to be the total measure of fluid of the receiving tanks (here 150 ml) multiplied by D1, which is the decimal portion of N1 (at 410).

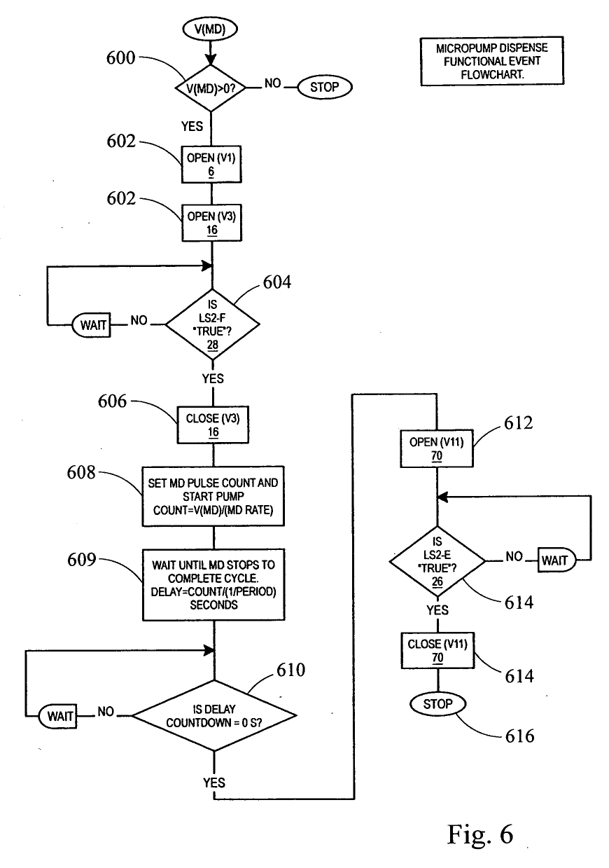

FIG. 6 shows the process of dispensing fluid through the micro dispenser 36 of the dispensing measuring system 2 described above, with the symbol references used in FIG. 2 being referenced here. After determining that V(MD) is not equal to zero (D1 is not equal to zero) (at 600), the valve 6 and the inlet valve 16 will open (at 602) and will fill the receiving tank 24 (assuming the micro dispenser 36 is connected with the receiving tank 24 and not receiving tank 22) until the sensor 28 indicates the receiving tank 24 contains a measure of fluid (at 604), at which time the valve 6 and the inlet valve 16 will close (at 606). The micro dispenser 36 will then be actuated and will start pumping fluid from the receiving tank 24 according to a pulse count (at 608). The pulse count is the number of seconds the micro dispenser 36 will pump fluid and is determined by V(MD) (calculated at 410) divided by the pump rate of the micro dispenser, which is determined by the type of micro dispenser used and the setting the micro dispenser is adjusted at. For example, if a micropump is used, the micropumps available from Bio-Chem Valve, Inc., discussed above, have pump rates in the range of 2-30 ml per minute. The pulse count decreases as the micro dispenser pumps fluid (at 609). The micro dispenser will stop pumping fluid when the pulse count reaches zero (at 610). Because no single shots are being dispensed, any fluid remaining within the receiving tank 24 will egress through the dispenser valve 70 (at 612). The valve will allow fluid remaining in the receiving tank 24 to exit to the drain 76 until the sensor 26 senses that no more fluid remains within the receiving tank 24 (at 614). When no more fluid is sensed within the receiving tank, the process stops (at 616).

If D1 is greater than 0.33, it is next determined if D1 is greater than 0.66) (at 412). The value of 0.66 is determined by dividing the larger measure of fluid of the receiving tanks 22, 24 by the total measure of fluid of the receiving tanks. In this example, this value is 100 divided by 150. Note that this value would change if the sensor 28 was adjusted to sense a measure of fluid within the receiving tank 22 at a value less than the total volumetric capacity (100 ml) of the receiving tank 22. If D1 is greater than 0.66, fluid will be dispensed from the micro dispenser 36 in an amount equal to D1 multiplied by 150 minus 100 ((D1*150)−100) (at 414). In addition, one 100 ml single shot of fluid will be dispensed.

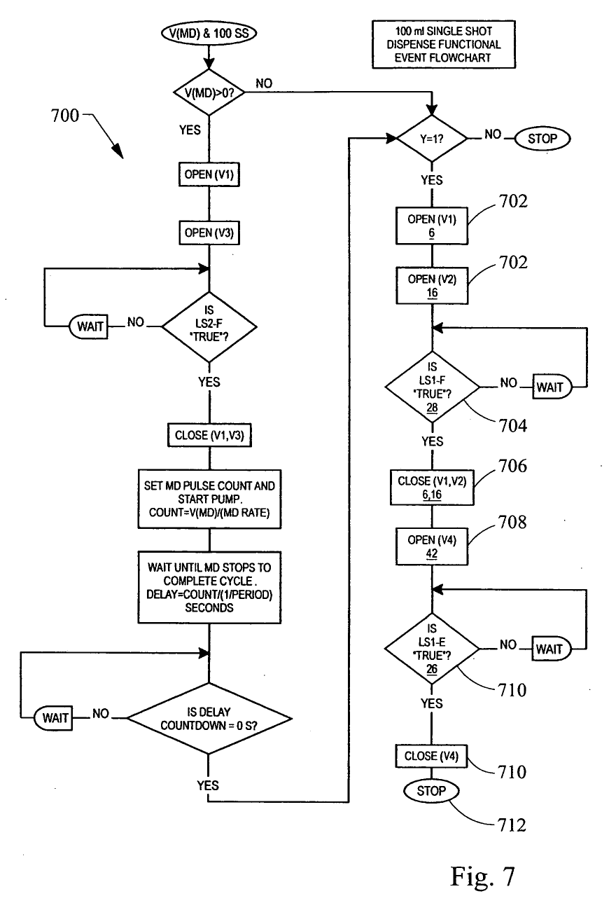

FIG. 7 shows the process of dispensing fluid through the micro dispenser 36 and the 100 ml receiving tank of the dispensing measuring system 2, with the symbol references and reference numbers used in FIG. 2 being referenced here. Dispensing fluid through the micro dispenser has already been described (at 700). Once fluid has passed through the micro dispenser, instead of fluid exiting through the dispenser valve 70, the inlet valve 16 associated with the receiving tank 22 will open to allow fluid to flow into the receiving tank 22 (at 702). The sensor 28 will sense a measure of fluid within the receiving tank (at 704), at which time the valve 6 and the inlet valve 16 will close (at 706) and the outlet valve 42 will open (at 708). The outlet valve will allow fluid to flow to the mix tank 40 and will remain open until the sensor 26 senses no fluid within the receiving tank 22 (at 710). Thus a 100 ml single shot will have been dispensed into the mix tank (at 712).

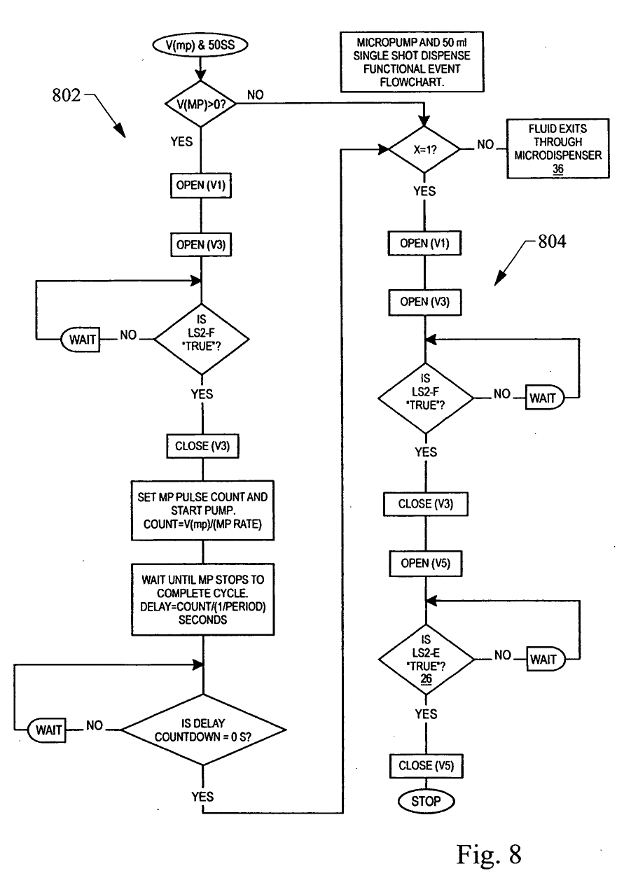

If D1 is less than or equal to 0.66, fluid will be dispensed from the micropump in an amount equal to D1 multiplied by 150 minus 50 ((D1*150)−50) (at 416). In addition, one 50 ml single shot of fluid will be dispensed. FIG. 8 shows the process of dispensing fluid through the micro dispenser 36 (at 802) and the 50 ml receiving tank (at 804) of the dispensing measuring system 2, with the symbol references and reference numbers used in FIG. 2 being referenced here. This process is the same as the process described for dispensing a single shot of 100 ml of fluid, except that the valves and sensors of the feedline 9 associated with the 50 ml receiving tank 24 will be used.

Once the chemicals are each dispensed into the mix tank 40, deionized water is added to the mix tank via the water valve 64. As noted above, water is added until the second mix sensor 43 senses fluid. However, deionized water may be added prior to the dispensing of chemicals or may be sequenced to be added before and after the dispensing of chemicals. The volume of deionized water introduced into the mix tank prior to the dispensing of chemicals could be measured based on the flow rate of the deionized water and the amount of time deionized water is allowed to flow into the mix tank. The volume of deionized water introduced into the mix tank after the dispensing of chemicals would be based on the second mix sensor 43 as described above.

The chemicals and deionized water in the mix tank are mixed into a homogenous mixture. The mixing of the fluids may be accomplished in several ways. For example, the fluids may freely combine until each fluid disperses in the solution. Mixing may also be accomplished by using the introduction of deionized water to create agitation within the mix tank, thus allowing the fluids to mix. Alternatively, mixing may be accomplished through stirring the fluids via magnetic bars or agitating rods.

As noted above, when it is desired to flush out or otherwise clean the mix tank, deionized water may be introduced into the mix tank 40 via the water valve 64, which allows the first source of deionized water 90 to be introduced. The deionized water within the mix tank may then be purged through drain valve 60 to the drain 62. Similarly, in order to flush out the receiving tanks, micro dispenser and associated valves, a second source of deionized water 92 may be introduced into the system 2. A check valve 94 associated with the second source of deionized water 92 prevents the back flow of fluid. Deionized water may then be purged through the drain 62 as described above. Note that cleaning fluids may also be introduced at the first and second sources of deionized water 90, 92 in order to clean the system. Deionized water may then be used to flush the system.

Thus, a novel apparatus for precisely dispensing fluid and a method for dispensing the fluid is disclosed. The dispensing measuring system allows fluid to be dispensed in a precise fashion, which is important so that the workpieces will not be damaged by the application of an improperly mixed chemical batch. The system also works quickly, so that workpieces may be processed quickly.

The dispensing measuring system may be modified without departing from its intended scope. For example, several dispensing measuring systems may be connected to one mix tank. Furthermore, more or less than two mix tanks may be used and more than one micropump may be incorporated if desired. It is therefore intended that the foregoing detailed description be regarded as illustrative rather than limiting, and that it be understood that it is the following claims, including all equivalents, that are intended to define the spirit and scope of this invention.

1. A method for dispensing fluid through a fluid dispensing measuring system for use with a system to treat semiconductor workpieces, the fluid dispensing measuring system having at least a first receiving tank having a volumetric capacity for receiving a first measure of fluid, a first sensor for sensing the first measure of fluid within the first receiving tank, a mix tank connected with the first receiving tank, a mix sensor for sensing a batch of fluid, and a source of fluid, comprising:
a) providing the first measure of fluid from the source to the first receiving tank;
b) sensing with the first sensor when the first measure of fluid has been received by the first receiving tank; and
c) transferring the first measure of fluid from the first receiving tank to the mix tank.

2. The method of claim 1, further comprising:
a) providing a source of deionized water to the mix tank until the mix sensor senses the batch of fluid; and
b) transferring the batch of fluid from the mix tank to a process apparatus.

3. The method of claim 1 further comprising:
a) concurrently providing a second measure of fluid from the source to a second receiving tank when the first measure of fluid is provided to the first receiving tank;
b) sensing with a second sensor when the second measure of fluid has been received by the second receiving tank; and
c) concurrently transferring the second measure of fluid from the second receiving tank to the mix tank when the first measure of fluid is transferred from the first receiving tank to the mix tank; and
d) repeating a)-f) until a set volume of the source of fluid has been transferred to the mix tank.

4. The method of claim 1, wherein providing a first measure of fluid from the first source to the first receiving tank further comprises:
pumping less than the first measure of fluid from the first receiving tank to the mix tank with a micro dispenser; and
providing the first measure of fluid from the first source to the first receiving tank.

5. A method for dispensing fluid through a fluid dispensing measuring system having at least a first receiving tank having a volumetric capacity, a sensor electrically connected to the receiving tank, a micropump connected to the first receiving tank, a mix tank connected with the first receiving tank and the micropump, a mix sensor, and a source of fluid and deionized water, comprising:
a) providing a first measure of fluid from the source to the first receiving tank;
b) sensing with the sensor when the first measure of fluid has been received by the first receiving tank; and
c) pumping less than the first measure of fluid from the first receiving tank to the mix tank with a micro dispenser.

6. The method of claim 5, further comprising:
a) providing the first measure of fluid to the first receiving tank;
b) sensing with the sensor when the first measure of fluid has been received by the first receiving tank; and
c) transferring the first measure of fluid from the first receiving tank to the mix tank.

7. The method of claim 5 further comprising:
a) purging fluid in the first receiving tank into a drain.
